(19) United States
(12) Patent Application Publication
(10) Pub. No.: US 2025/0259094 A1
(43) Pub. Date: Aug. 14, 2025

(54) QUANTUM ERROR CORRECTING CODES FROM HIGHER GRASSMANN CODES

(71) Applicants: Ohio State Innovation Foundation, Columbus, OH (US); The Administrators of the Tulane Educational Fund ("TU"), New Orleans, LA (US); The Curators of the University of Missouri, through its University Constituent, the University of, St. Louis, MO (US)

(72) Inventors: Roy JOSHUA, Dublin, OH (US); Mahir Bilen CAN, New Orleans, LA (US); Ravindra GIRIVARU, Clayton, MO (US)

(21) Appl. No.: 18/857,325

(22) PCT Filed: Apr. 18, 2023
(86) PCT No.: PCT/US2023/018890

§ 371 Date: Oct. 16, 2024

Related U.S. Application Data
(60) Provisional application No. 63/331,979, filed on Apr. 18, 2022.

(51) Int. Cl. G06N 10/70

(52) U.S. Cl. CPC G06N 10/70

(57) ABSTRACT

Systems and methods to construct Quantum Error Correcting codes from Higher Grassmann Codes. The present disclosure is directed to algebraic codes obtained from families of imbeddings of the Grassmannian, constructed as the composition of a diagonal imbedding followed by a Segre imbedding into various high dimensional projective spaces. As a result, a large family of new error correcting codes is obtained, and the parameters of such codes are determined.

### CROSS-REFERENCE TO RELATED APPLICATION

This is a national phase application under 35 U.S.C. § 371 that claims priority to PCT/US2023/018890, filed Apr. 18, 2023, that further claims priority to U.S. Provisional Patent Application No. 63/331,979, filed Apr. 18, 2022, each entitled “QUANTUM ERROR CORRECTING CODES FROM HIGHER GRASSMANN CODES,” the disclosures of which are incorporated herein by reference in their respective entireties.

### FIELD OF THE INVENTION

The present invention relates to error correcting codes, and more specifically, to the construction of Quantum Error Correcting codes from the Higher Grassmann Codes.

### BACKGROUND

Error correcting codes play an important role: classically they have been used to correct transmission errors, but lately these also play a key role in quantum computation in the form of quantum error correcting codes which prevent decoherence. One important class of error correcting codes are the ones constructed using the methods of Algebraic geometry from algebraic varieties defined over finite fields. The Grassmann varieties form a familiar class of well understood algebraic varieties. For example, the Grassmann variety of k-dimensional subspaces of a fixed n-dimensional vector space over a finite field F_q is a smooth projective variety: the way it gets the structure of a projective variety is by making use of the well-known Plucker imbedding. The corresponding Grassmann code is obtained by evaluating the sections of the restriction of the canonical line bundle on the ambient projective space at the F_q-rational points on the Grassmannian. Such Grassmann codes are generalization of Reed-Muller codes, which have been used in classical error correction. To date, the only Grassmann codes considered have been codes obtained from the classical Plucker imbedding, though there are many other possible projective imbeddings.

### SUMMARY

The present disclosure is directed to algebraic codes obtained from families of imbeddings of the Grassmannian, constructed as the composition of a diagonal imbedding followed by a Segre imbedding into various high dimensional projective spaces. As a result, a large family of new error correcting codes is obtained and the parameters of such codes are determined.

In accordance with the present disclosure, an apparatus to encode and decode quantum [[n; k; d]] stabilizer codes is disclosed. The apparatus includes an encoder that entangles a quantum data register |ψ [symbol] _{D}=|ψ₁ψ₂ . . . ψₖ [symbol] with redundancy qubits |0 [symbol] _{R}=|0₁0₂ . . . 0ₙ₋ₖ [symbol] to create a logical qubit |ψ [symbol] _{L}; and stabilizer check logic that, after encoding, performs a sequence of n−k stabilizer checks Pᵢ on the quantum data register and that copies each result to an ancilla qubit Aᵢ. A subsequent measurement of the ancilla qubits provides an m-bit syndrome.

In accordance with yet another aspect of the disclosure, a method to encode and decode quantum [[n; k; d]] stabilizer codes error correcting codes from higher Grassmann codes is disclosed. The method includes generating higher Grassmann codes that are imbedded as sub-codes of in a higher-order projective space ( [symbol] ^{m}) that corresponds to line bundles [symbol] (v) on the Grassmann variety; entangling a quantum data register |ψ [symbol] _{D}=|ψ₁ψ₂ . . . ψₖ [symbol] with redundancy qubits |0 [symbol] _{R}=|0₁0₂ . . . 0ₙ₋ₖ [symbol] that use the higher Grassmann codes to create a logical qubit |ψ [symbol] _{L}; performing a sequence of n−k stabilizer checks Pᵢ on the quantum data register and copying each result to an ancilla qubit Aᵢ; and performing a subsequent measurement of the ancilla qubits to provide an m-bit syndrome.

In accordance with yet another aspect, a method for active recovery in a quantum error correction code is disclosed that includes performing an error process E on a logical qubit |ψ [symbol] _{L} of an [[n, k, d]] stabilizer code; measuring a generating set of stabilizers S on a logical state to yield an m-bit syndrome [symbol] ; and processing the m-bit syndrome [symbol] by a decoder to determine a best recovery operation [symbol] to return the logical state to a codespace. After the recovery operation has been applied, the output of an error correction cycle is [symbol] E|ψ [symbol] _{L}.

The following is a non-exhaustive list of the advantages these codes have over the classical Grassmann codes:
First the dimension of the new codes we obtain are greater than the dimension of the classical Grassmann codes
Over large fields, the minimum distance of our codes are asymptotically the same as those of the classical Grassmann codes.
One key application of these new codes is to quantum error correction, which we plan to explore.

Thus, a significant advantage is gained by considering these geometric codes.

The foregoing illustrative summary, as well as other exemplary objectives and/or advantages, and the manner in which the same are accomplished, are further explained within the following detailed description and its accompanying drawings.

### BRIEF DESCRIPTION OF THE DRAWINGS

A detailed description of certain aspects of the present disclosure in accordance with various example implementations will now be provided with reference to the accompanying drawings. The drawings form a part hereof and show, by way of illustration, specific implementations and examples. In referring to the drawings, like numerals represent like elements throughout the several figures.

FIG. 1 illustrates the Young diagram of (7,3,3,2,1);

FIG. 2 illustrates the Young diagrams of the integer partitions whose Young diagram fits in a 2×2 grid;

FIG. 3 illustrates the Plücker coordinates of Gr(l, V);

FIG. 4 illustrates the Grassmann variety Gr(2, V) and its Schubert varieties;

FIG. 5 illustrates a semistandard Young tableau of shape (5,4,3);

FIG. 6 illustrates the coordinates of the boxes of (5,4,3);

FIGS. 7A and 7B illustrate the content and hook lengths of the boxes of (5,4,3);

FIG. 8 illustrates the set of SSYT of shape (2,2) with entries from {1,2,3};

FIGS. 9A and 9B illustrate the contents and hook lengths for the boxes of (r, . . . , r, 0, . . . , 0);

FIG. 10 illustrates a schematic of Grassmann codes as subset of Projective RM codes;

FIG. 11 illustrates a circuit diagram Circuit illustrating the structure of an [[n; k; d]] stabilizer code; and

FIG. 12 illustrates a general procedure for active recovery in a quantum error correction code.

### DETAILED DESCRIPTION

Unlike digital computing, error correction plays a key role in quantum computing. This is because of the effect of decoherence, where the data will get corrupted very rapidly by interference with the environment, unless error correction is applied at nearly every stage of the computational process. As such, any improvements in quantum error correcting technology is of immense importance presently.

### Introduction

Throughout the disclosure, [symbol] _{q} will denote the finite field with q elements, where q is a power of a prime number, p. Moreover, we will restrict to schemes of finite type defined over such a finite field. Let X denote the Grassmann variety of l-dimensional subspaces of a fixed m-dimensional vector space V. One way to obtain the projective variety structure on X is via the Plücker embedding p: X

[symbol]

$${ℙ}^{( \begin{matrix}m \\ l\end{matrix} ) - 1}$$

The corresponding Grassmann code is obtained by evaluating sections of the line bundle on X obtained as the restriction of the canonical line bundle on

$${ℙ}^{( \begin{matrix}m \\ l\end{matrix} ) - 1}$$

at the [symbol] _{q}-rational points on X. The Grassmann codes are natural generalizations of the well-known Reed-Müller codes. A significant advantage in efficiency is gained by considering these geometric codes. Indeed, already in the case of projective spaces, the performance of the projective Reed-Müller codes, compared to the classical generalized Reed-Müller codes, are much better. The parameters for a general Grassmann code over [symbol] _{q} was computed.

In the present context, by a projective embedding of an algebraic variety or a scheme X, we mean a closed immersion of X into a projective space [symbol] ^{m}. One may consider many other projective embeddings of the Grassmannian other than the Plücker embedding. For example, let ι: Gr(l, V)→ [symbol] ((∧^{l}V)^{⊗r}) denote the projective embedding of Gr(l, V) that is obtained by composing the diagonal Plücker embedding with the r-fold Segre embedding of Π^{r} [symbol] (∧^{l}V). The resulting code is obtained by evaluating the global sections of the restriction of the canonical line bundle on the corresponding projective space to the Grassmannian, at the [symbol] _{q}-rational points of the Grassmannian. The present disclosure describes a methodology to explicitly determine the parameters of all such codes obtained from the Grassmannian. This is part of a larger effort to compute parameters of codes produced from the large class of algebraic varieties called projective spherical varieties, which contain as special cases the class of all projective embeddings of Grassmannians, flag varieties as well as toric varieties.

When l=1, the Grassmann variety Gr(l, V) is equal to the projective space of lines in V, that is, [symbol] (V)≅ [symbol] ^{m-1}. In this case we get the projective Reed-Müller codes; for every r∈ [symbol] , the relevant embedding is provided by the r-th symmetric power of V. Herein, we consider higher dimensional projective spaces to embed the Grassmann variety, such as via the composition of the diagonal Plücker embedding with the Segre embedding.

Let x denote a variable and let a be a positive integer. Then the a-th rising factorial of x, denoted by x^{(a)}, is the product x^{(a)}=x(x+1) . . . (x+a−1).

Let q denote a power of a prime number p. It is convenient to denote by [m]_{q} the polynomial

$$1 + q + … + {q}^{m - 1} = \frac{{q}^{m} - 1}{q - 1} ,$$

which is often called the q-analog of m since its evaluation at q=1 is m. The q-factorial of m is defined by [m]_{q}!:=[m]_{q}[m−1]_{q} . . . [2]_{q}[1]_{q}. As convention, we set [0]_{q}:=1. For l∈{0, . . . , m}, the q-binomial coefficient

$${[ \begin{matrix}m \\ l\end{matrix} ]}_{q}$$

is defined by

$${[ \begin{matrix}m \\ l\end{matrix} ]}_{q} := \frac{{[ m ]}_{q} !}{{{[ m - l ]}_{q} ! [ l ]}_{q} !} .$$

It is well-known that, if q is a power of a prime number, then

$${[ \begin{matrix}m \\ l\end{matrix} ]}_{q}$$

is the [symbol] _{q}-rational points of the Grassmann variety of l-dimensional subspaces of an m-dimensional vector space. Also, there is an elementary combinatorial interpretation of

$${[ \begin{matrix}m \\ l\end{matrix} ]}_{q}$$

in terms of partitions of integers.

Moreover, one may recall the following standard terminology used in coding theory. A k-dimensional vector subspace W in an n-dimensional vector space V defined over [symbol] _{q} is called an [n, k, d]_{q}-code. Here, d is defined as the minimum of the distances between distinct elements of W; the distance is defined by the number of coordinates where two vectors differ from each other. The integer n is often called the length of the code, and k is called the dimension of the code.

Let {e₁, . . . , eₙ} denote the standard basis for [symbol] _{q}ⁿ, and let x₁, . . . , xₙ denote the corresponding coordinate functionals on [symbol] _{q}ⁿ. An [n, k, d]_{q}-code W⊂ [symbol] _{q}ⁿ is said to be nondegenerate if W is not contained in any of the following coordinate hypersurfaces:

$${H}_{i} : = \{ v ∈ {𝔽}_{q}^{n} : {x}_{i} ( v ) = 0 \} ≅ {𝔽}_{q}^{m - 1} ( i ∈ \{ 1 , … , n \} ) .$$

There is a 1-1 correspondence between the set of equivalence classes of nondegenerate [n, l, d]_{q}-codes and the set of equivalence classes of projective [n, k, d]_{q}-systems, which are defined as follows.

Let X be an algebraic variety with n [symbol] _{q}-rational points. Let φ: X→ [symbol] ^{m-1} be an embedding and let x₁, . . . , xₙ denote the images of the [symbol] _{q}-rational points of X in [symbol] ^{m-1}. Let E denote the [symbol] _{q}-vector space [symbol] _{q}^{m}, and let y₁, . . . , yₙ denote (arbitrary) liftings of x₁, . . . , xₙ to E\{0} in the given order. Then we get an evaluation map on the linear forms of E,

$$ev : {E}^{*} \to {𝔽}_{q}^{n} \qquad ( 1.1 )$$

$$f ↦ ( f ( {y}_{1} ) , … , f ( {y}_{n} ) ) .$$

The image of ev, denoted by C, is the projective [n, k, d]_{q}-system associated with φ. Note that the length of C is n, its dimension is k=m−dimker(ev), and its minimum distance is given by

$$d = min \{ \vert X ( {𝔽}_{q} ) \vert - \vert X ( {𝔽}_{q} ) ∩ ker ( f ) \vert : f ∈ E ⋆ and X ( {𝔽}_{q} ) ⊄ ke r ( f ) \} .$$

As before, let V be an m dimensional vector space over [symbol] _{q}. The points in the image of the Plücker embedding p:

$$Gr ( l , V ) \to {ℙ}^{( \begin{matrix}m \\ l\end{matrix} ) - 1}$$

can be viewed as projective [n, k, d]_{q}-systems, where

$$n = {[ \begin{matrix}m \\ l\end{matrix} ]}_{q} and k = ( \begin{matrix}m \\ l\end{matrix} ) .$$

These projective systems (or rather the codes corresponding to these projective systems) are called the (classical) Grassmann codes.

The material in paragraphs [0024] through [0037] and [0041] through [0058] are background material, setting up the framework for the subsequent discussion. One main result is discussed in paragraph [0040] as well as in paragraphs [00109] through [00113] and another main result is discussed in paragraph [00152] The first step in our algorithm is discussed in paragraphs [0060] through [0066], while the second step is discussed in paragraphs [00119] through [00124]. The third step is discussed in paragraphs [00125] through [00150] and the fourth step is discussed in paragraphs [00153] through [00160]. The fifth and final step of our algorithm is discussed in paragraph [00160]. The implementation details of our algorithm are discussed in paragraphs [00161] through [00166].

Adopting the above notation, we now present a special case of our main theorem, which is recorded as Theorem 4.1 in the sequel.

Theorem 1.3. Let ι: Gr(l, V)→ [symbol] ((∧^{l}V)^{⊗r}) denote the projective embedding of Gr(l, V) that is obtained by composing the diagonal Plücker embedding with the r-fold Segre embedding of Π^{r} [symbol] ((∧^{l}V). If C is the projective [n, k, d]_{q}-system corresponding to ι, then for every sufficiently large prime characteristic p>0, the parameters of C satisfy the following conditions:

$$1. \qquad n = {[ \begin{matrix}m \\ l\end{matrix} ]}_{q} = \frac{{[ m - 1 ]}_{q} {… [ m - l + 1 ]}_{q}}{{{[ 1 ]}_{q} [ 2 ]}_{q} {… [ l ]}_{q}}$$

$$2. \qquad k = \frac{{{m}^{( r )} ( m - 1 )}^{( r )} … {( m - l + 1 )}^{( r )}}{{1}^{( r )} {2}^{( r )} … {l}^{( r )}} ,$$

$$3. \qquad {q}^{l ( m - l )} - r {q}^{l ( m - l ) - 1} \leq d \leq {q}^{l ( m - l )} - ( r - 1 ) {q}^{l ( m - l ) - 1} .$$

We know that the upper bound for the minimum distance is achieved for r=1 as well as for l=1. We conjecture that the upper bound is always achieved. Note that as a polynomial in q, the leading term of n in Theorem 1.3 is q^{l(m-l)}. Also, the coefficient of q^{l(m-l)-1} in n is 1. (We will justify these statements in Section 2 by using a simple, well-known combinatorial argument.) Then the leading term of the difference n−d is given by rq^{l(m-l)-1}. It follows that, if we fix r, then for every sufficiently big q, the difference n−d is greater than k. In other words, our codes satisfy the Singleton bound for sufficiently large values of q. Let us point out that there is an effective way, due to Jantzen, to check how small the characteristic p can be in order for our theorem to hold.

Next, we want to point out some facts about the parameters of our codes. First of all, for r>1, it is easy to see by an inductive argument that the dimensions of our codes are all greater than

$$( \begin{matrix}m \\ l\end{matrix} ) ,$$

which is the dimension of Grassmann codes obtained from the Plücker embedding. On the other hand, it is already apparent from the r=2 case of Theorem 1.3 that our codes may have smaller minimum distance compared to the ordinary Grassmann codes (r=1). Nevertheless, as q→∞, the dominating term of the minimum distance of our code is also given by q^{l(m-l)}. Therefore, on finite fields with big characteristic exponents, our codes become more advantageous compared to the ordinary Grassmann codes.

The present disclosure is structured as follows. Below, we set up our notation, and we review some basic representation theory and algebraic geometry facts regarding Grassmann and Schubert varieties. In Section 3, we analyze the Białynicki-Birula decomposition of Gr(l, V) in relation with that of [symbol] (∧^{l}V). Next, we prove our main result by giving a lower bound for the dimension of C for small prime characteristics. By applying Weyl's dimension formula to calculate this lower bound, we conclude by proving Theorem 1.3 in Section 4.1.

### Preliminaries

In this section we will introduce the most basic objects and notation for our paper. We recall that we will restrict to schemes of finite type defined over a fixed finite field [symbol] _{q}.

For a positive integer m∈ [symbol] , we will use the notation [m] to denote the finite set {1, . . . , m}. For l∈[m], the set of all l-element subsets of [m] is denoted by

$$( \begin{matrix}[ m ] \\ l\end{matrix} ) .$$

We view

$$( \begin{matrix}[ m ] \\ l\end{matrix} )$$

as a chain, where the total order is given by the lexicographic ordering. More precisely, we view the elements of

$$( \begin{matrix}[ m ] \\ l\end{matrix} )$$

as increasing sequences of l-tuples of integers from [m], and we order them lexicographically. The lexicographic order on

$$( \begin{matrix}[ m ] \\ l\end{matrix} )$$

will be denoted by [symbol] In particular, whenever

$$( \begin{matrix}[ m ] \\ l\end{matrix} )$$

appears as an indexing set of some vector, we always assume that its elements are ordered according to [symbol] . We will refer to an element of

$$( \begin{matrix}[ m ] \\ l\end{matrix} )$$

as an l-subset.

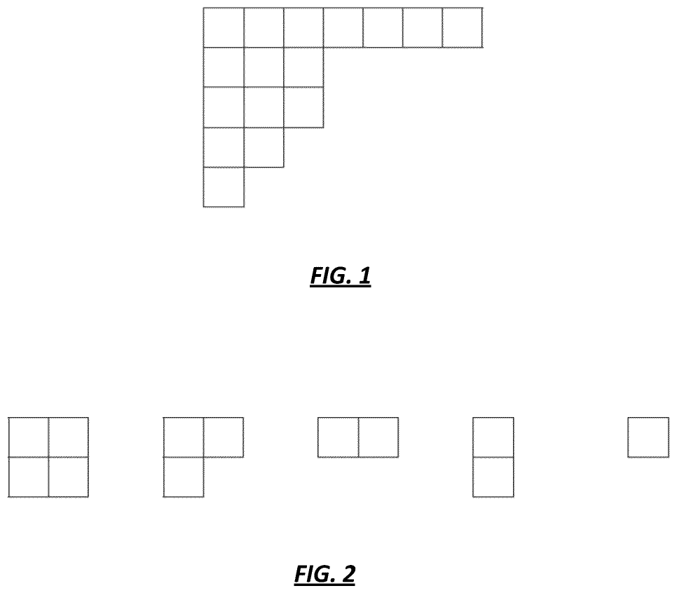

An integer partition of m is a non-increasing sequence of positive numbers λ=(λ₁, . . . , λₛ) such that Σᵢ₌₁^{s}λᵢ=m. The Young diagram of λ is a top-left justified arrangement of the boxes with λᵢ boxes in the i-th row. For example, the Young diagram of the integer partition λ=(7,3,3,2,1) of 16 is shown in FIG. 1.

The coefficient of the monomial q^{a} in

$${[ \begin{matrix}m \\ l\end{matrix} ]}_{q}$$

is given by the number of integer partitions of a whose Young diagram fit into an l×(m−l) grid. This well-known combinatorial fact is a direct consequence of the decomposition of the Grassmann variety Gr(l, [symbol] _{q}^{m}) into Schubert cells, which we will review in the sequel. By abuse of notation, let us use λ⊆l×(m−l) to indicate that the Young diagram of the integer partition λ fits inside the l×(m−l) grid. Then we have the following polynomial identity which summarizes our discussion:

$${[ \begin{matrix}m \\ l\end{matrix} ]}_{q} = 1 + {\sum }_{λ ⊆ \times ( m - l )} {q}^{\# of boxes in λ} .$$

Thus, the coefficients of the monomials q^{l(m-l)} and q^{l(m-l)-1} in

$${[ \begin{matrix}m \\ l\end{matrix} ]}_{q}$$

are equal to 1. In particular, the leading term of

$${[ \begin{matrix}m \\ l\end{matrix} ]}_{q}$$

is q^{l(m-l)}. We used this fact to justify (in the introduction) the fact that our codes in Theorem 4.1 satisfy the Singleton bound.

Let m=4, l=2. Then, there are 5 integer partitions whose Young diagram fits into 2×2 grid. We depicted the Young diagrams of these integer partitions in FIG. 2.

It follows from the list of Young diagrams in FIG. 2 that

$${[ \begin{matrix}4 \\ 2\end{matrix} ]}_{q} = 1 + q + 2 {q}^{2} + {q}^{3} + {q}^{4} .$$

We finish this subsection by introducing another commonly used notation. The multiplicative group of nonzero entries in [symbol] _{q}^{×} will be denoted by [symbol] ₘ.

### 2.1 The Grassmann Varieties

Let K be a field. Let SLₘ denote the group of m×m matrices with determinant 1 with entries from K. The diagonal maximal torus in SLₘ, denoted by Tₘ, is a split torus. The Borel subgroup of upper triangular matrices in SLₘ, denoted by Bₘ, contains Tₘ. We denote by X(Tₘ) the group of rational characters of Tₘ, and the dual of X(Tₘ), that is Ho [symbol] (X(Tₘ), [symbol] ), is denoted by Y(Tₘ). The nondegenerate bilinear pairing between X(Tₘ) and Y(Tₘ) will be denoted by [symbol] . The Weyl group of SLₘ is isomorphic to Sₘ, the symmetric group of permutations of the set [m]. It acts on Tₘ by conjugation, hence, it acts on the groups X(Tₘ) and Y(Tₘ). However, the pairing [symbol] is Sₘ-invariant. The root system of the pair (SLₘ, Tₘ) will be denoted by R. Explicitly, it is given by the set of vectors R={εᵢ−εⱼ: 1≤i, j≤m}, where {ε₁, . . . , εₘ} is the standard basis for the m-dimensional Euclidean [symbol] -vector space. The system of positive roots determined by Bₘ, denoted by R⁺, is given by R⁺={εᵢ−εⱼ: 1≤i<j≤m}. The subset of simple roots in R⁺ will be denoted by S; it is given by S={αᵢ: αᵢ=εᵢ−249 ᵢ₊₁, 1≤i≤m−1}. The duals of the basis vectors αᵢ (1≤i≤m−1) are denoted by αᵢ^{V}, and the fundamental weights ω̅ᵢ (1≤i≤m−1) are defined by equations

$$〈 {\overline{ω}}_{i} , {α}_{j}^{⋁} 〉 = \{ \begin{matrix}1 & if i = j \\ 0 & otherwise\end{matrix}$$

for αⱼ∈S. Note that the i-th fundamental weight ω̅ᵢ is the highest weight vector of the i-th fundamental representation ∧ⁱ k of SLₘ. The submonoid generated by w̅ᵢ (1≤i≤m−1) in X(Tₘ), denoted by X(Tₘ)₊, is the monoid of dominant weights. Then we have,

$${X ( {T}_{m} )}_{+} = \{ λ ∈ X ( {T}_{m} ) : 〈 λ , {α}_{i}^{⋁} 〉 \geq 0 for ever y {α}_{i} ∈ S \} .$$

It is well-known that for every finite dimensional irreducible representation W of SLₘ, there is a unique dominant weight λ∈X(Tₘ)₊ called the highest weight of W. In other words, simple SLₘ-modules are parametrized by the elements of X(Tₘ)₊.

Since it is the point of departure for our paper, we will briefly review the definition of the Plücker embedding. Let V be an m-dimensional vector space. We fix a basis {e₁, . . . , eₘ} of V. Note that an l-dimensional subspace M of V can be identified with an l×m matrix A=A(M), where the rank of A is l. Indeed, the rows of such a matrix span an l-dimensional vector subspace; two such matrices A₁, A₂ span the same vector subspace if and only if there exists g∈GLₗ such that A₁=gA₂.

Let Mat_{l,m} denote the space of l×m matrices (over a field) and let Mat_{l,m}⁰ denote the Zariski open subset consisting of rank l matrices. Then GLₗ acts by the left matrix multiplication on Mat_{l,m}⁰, and the quotient is precisely the Grassmann variety Gr(l, V). In this interpretation, the elements of Gr(l, V) are the equivalence classes of matrices [A] where A∈Mat_{l,m}⁰. The Plücker embedding of Gr(l, V) is defined by p: Gr(l, V)→

$${ℙ}^{( \begin{matrix}m \\ l\end{matrix} ) - 1} , [ A ] ↦ {( det {A}_{I} )}_{I ∈ ( \begin{matrix}[ m ] \\ l\end{matrix} )} ,$$

where A_{I} is the l×l-minor of A determined by the columns indexed by I.

Finally, let us point out the fact that Gr(l, V) is a homogeneous space for SLₘ as well as for GLₘ:

$$Gr ( l , V ) ≅ {SL}_{m} / {Stab}_{{SL}_{m}} ( 〈 {e}_{1} , … , {e}_{l} 〉 ) ≅ {GL}_{m} / {Stab}_{{GL}_{m}} ( 〈 {e}_{1} , … , {e}_{l} 〉 ) .$$

Here, [symbol] e₁, . . . , eₗ [symbol] is the l-dimensional subspace spanned by e₁, . . . , eₗ in V.

### 2.2 Projective Embeddings of Gr(l, V)

Let V denote the m-dimensional K-vector space K^{m} with the standard basis {e₁, . . . , eₘ}. The l-th fundamental representation of SLₘ is given by the l-th exterior power of V. It is well-known that the Picard group of Gr(l, V) is generated by the ample line bundle [symbol] (ω̅ₗ).

The dual of the space of global sections, that is H⁰(Gr(l, V), [symbol] (ω̅ₗ))*, is isomorphic to ∧^{l}V. Therefore, the Plücker coordinates on Gr(l, V) are given by the restrictions of the coordinate functions on the affine space

$${𝔸}^{( \begin{matrix}m \\ l\end{matrix} )} ≅ {⋀}^{l} V .$$

Next, we will consider the space of global sections of the line bundle [symbol] (rω̅ₗ), where r is a positive integer. Since [symbol] (rω̅ₗ) is very ample, it gives a closed embedding,

$${τ}_{r} : {Gr ( l , V )}^{t} ℙ ( {{H}^{0} ( Gr ( l , V ) , ℒ ( r {ϖ}_{l} ) )}^{*} ) . \qquad ( 2.2 )$$

The analogs of Plücker coordinates for (2.2) are called the standard monomials. In this section, we will compute the parameters of the codes that we will construct from (2.2). Since the underlying idea of computations is the same for every r>1, we will present the simplest case, that is r=2.

To identify the projective space in (2.2), we first embed Gr(l, V) into [symbol] ^{s}× [symbol] ^{s}, where

$$s = {(}_{l}^{m} ) - 1 ;$$

this embedding is given by the composition of the diagonal embedding of Gr(l, V) into Gr(l, V)×Gr(l, V) followed by the doubled Plücker embedding. Then we use the Segre embedding to embed the doubled projective space into a bigger projective space. We denote the morphism defined by these compositions by ι. In summary, we have the following diagram:

$$ι : Gr ( l , V ) {\to }^{diag} Gr ( l , V ) \times Gr ( l , V ) {\to }^{p \times p} {ℙ}^{s} \times {ℙ}^{2} {\to }^{Segre} {ℙ}^{{s}^{2} + 2 s} , \qquad ( 2.3 )$$

We will describe explicitly the image of (2.3).

Let M be a point from Gr(l, V), and let (m₁, m₂, . . . , mₛ₊₁) denote its image under the Plücker embedding. Then we have

$$ι : M {↦}^{diag} ( M , M ) {↦}^{( p , p )} ( ( {m}_{1} , … , {m}_{s + 1} ) , ( {m}_{1} , … , {m}_{s + 1} ) ) {↦}^{Segre} {( {m}_{i} {m}_{j} )}_{{i = 1 , … , s + 1}_{j = 1 , … , s + 1}} . \qquad ( 2.4 )$$

Equivalently

$${( {m}_{i} {m}_{j} )}_{{i = 1 , … , s + 1}_{j = 1 , … , s + 1}}$$

is the point that is represented by the tensor product M⊗M in [symbol] (∧^{l}V⊗∧^{l}V).

We will show that ι is very useful for understanding the embedding (2.2). We proceed with some general remarks.

Let G be a connected reductive group, and let B be a Borel subgroup. Let P be a standard parabolic subgroup, that is, P is a parabolic subgroup and B⊂P. We assume that all of these (sub)groups are defined over K:= [symbol] _{q}.

There is a canonical projection map π: G/B→G/P, and for every locally free sheaf [symbol] on G/P, there is an isomorphism

$${H}^{0} ( G / P , 𝒮 ) \tilde{\to } {H}^{0} ( G / B , π * 𝒮 ) . \qquad ( 2.5 )$$

In our special case, if P is the maximal parabolic subgroup in G=SLₘ corresponding to the fundamental weight ω̅ₗ, and B is the Borel subgroup Bₘ, then we have the isomorphism

$${H}^{0} ( G / P , ℒ ( r {ϖ}_{l} ) ) \tilde{\to } {H}^{0} ( G / B , π * ℒ ( r {ϖ}_{l} ) ) \qquad ( 2.6 )$$

for every r∈ [symbol] ₊. Therefore, as far as our embedding (2.2) concerned, we can work with the SLₘ module H⁰(G/B, π* [symbol] (rω̅ₗ)). To be precise, we will work with the dual of this module.

Let T be a maximal torus such that T⊂B. For every λ∈X(T), we will use the abbreviation H⁰(rω̅ₗ):=H⁰(G/P, [symbol] (rω̅ₗ)). If λ is a dominant weight from X(T)₊, then the G-module, V(λ):=H⁰(−w₀λ)*, where w₀ is the longest element of the Weyl group W, is called the Weyl module associated with λ.

Thus, the following may be understood:

The formal characters of V(λ) and H⁰(λ) are always equal.

In characteristic 0, Weyl modules give irreducible representations of G, and furthermore, V(λ) is isomorphic to H⁰(λ). However, in characteristic p≠0, they (the Weyl modules) are in general non-simple. Nevertheless, the isomorphism V(λ)≅H⁰(λ) holds if V(λ) is simple. In this case, we can compute the dimension of V(λ) via Weyl character formula. Since this is a formal computation, it can be performed over [symbol] (hence over [symbol] ) as well.

For every field K and positive integer m∈ [symbol] , the exterior powers ∧^{l}K^{m} (1≤l≤m) are simple SLₘ-modules. More generally, (over a finite field K= [symbol] _{q}) there is an explicit characterization of the weights λ such that V(λ) is simple. It goes as follows: Let p denote the characteristic of K, and let ρ denote the weight ω̅₁+ . . . +ω̅ₘ₋₁. Then V(λ) is simple over K if and only if for each positive root α=εᵢ−εⱼ∈R⁺ with 1≤i<j≤m the following property holds: Let [symbol] λ+ρ, α^{V} [symbol] =ap^{s}+bp^{s+1}, where a, b, s are nonnegative integers such that 0<a<p. Then there should exist β₀, β₁, . . . , β_{b}∈R⁺ with [symbol] λ+ρ, βᵢ^{V} [symbol] =p^{s+1} for 1≤i≤b and [symbol] λ+ρ, β₀^{V} [symbol] =ap^{s} with α=Σᵢ₌₀^{b}βᵢ and with α−β₀∈R. Equivalently, there exist integers i=i₀<i₁< . . . <i_{b}<i_{b+1}=j such that {βᵢ: 0≤i≤b}={εᵢ_{ᵥ}−εᵢ_{ᵥ₊₁}: 0≤v≤b} and β₀∈{εᵢ−εᵢ_{₁}, εᵢ_{_{b}}−εⱼ}. Notice that for every sufficiently big prime number, we have b=s=0, hence, [symbol] λ+ρ, α^{V} [symbol] =a<p. In this case, all of the subsequent conditions automatically hold. Therefore, V(λ) is a simple SLₘ (K)-module.

### 2.3 Schubert Varieties in Gr(l, V)

Let G be an algebraic group and let B be a Borel subgroup of G. Let G/P be a projective homogeneous space, where P is a parabolic subgroup such that B⊆P. To a large extent, the geometry and the topology of G/P is determined by its Schubert subvarieties. By definition, a Schubert variety in G/P is the Zariski closure of a B-orbit in G/P. In the case of Grassmann varieties, they can be defined quite explicitly.

For a subset J⊂[m], we will denote by E_{J} the subspace [symbol] eⱼ: j∈J [symbol] . In particular, we will denote by E_{[j]}(j∈[m]) the subspace [symbol] e₁, . . . , eⱼ [symbol] . Let I={i₁, . . . , iₗ} be an element of

$$( \begin{matrix}[ m ] \\ l\end{matrix} ) .$$

The Schubert cell associated with I in Gr(l, V) is the affine space

$${C}_{I} := \{ W ∈ Gr ( l , V ) : dim ( W ⋂ {E}_{[ j ]} ) = \vert I ⋂ [ j ] \vert for every j ∈ [ m ] \} . \qquad ( 2.11 )$$

It is not difficult to verify that if I≠I′, then C_{I}∩C_{I′}=Ø. It is also not difficult to check that the union of all Schubert cells is equal to Gr(l, V). The decomposition

$$Gr ( l , V ) = {⊔}_{I ∈ ( \begin{matrix}[ m ] \\ l\end{matrix} )} {C}_{I} \qquad ( 2.12 )$$

is called the Bruhat-Chevalley decomposition of Gr(l, V).

The Zariski closure of C_{I} in Gr(l, V), called the Schubert variety associated with I, is given by

$${X}_{I} := \overline{{C}_{I}} = \{ W ∈ Gr ( l , V ) : dim ( W ⋂ {E}_{[ j ]} ) \geq \vert I ⋂ [ j ] \vert for every j ∈ [ m ] \} .$$

The intersection ring (the Chow ring) of Gr(l, V) is completely determined by the classes of Schubert varieties. For I={i₁, . . . , iₗ}, J={j₁, . . . , jₗ} from

$$( \begin{matrix}[ m ] \\ l\end{matrix} ) ,$$

the inclusion relationship between Xᵢ and X_{J} is given by the entry-wise comparisons:

$${X}_{I} ⊆ {X}_{J} ⇔ {i}_{r} \leq {j}_{r} for every r ∈ [ l ] . \qquad ( 2.13 )$$

We have an example of the Hasse diagram of this partial order in FIG. 4.

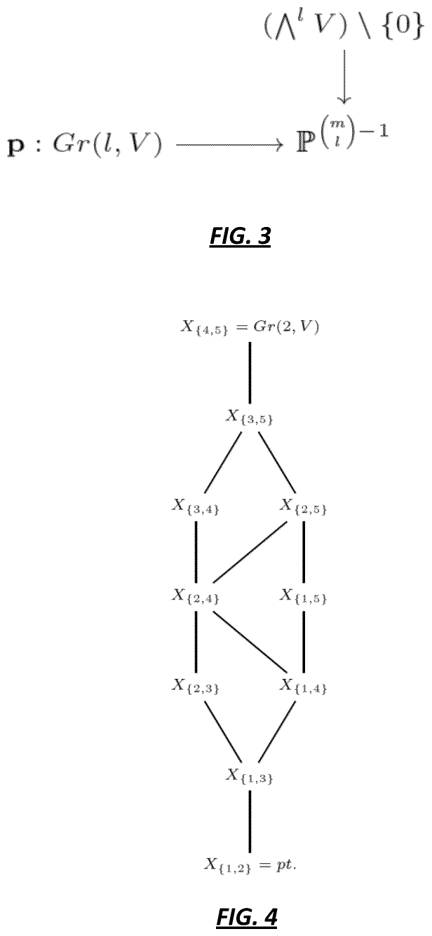

It is not difficult to check from (2.13) that the Schubert cell C_{{m-l+1,m-l+2, . . . , m}} is open and dense in Gr(l, V), and that, there is a unique one-codimensional Schubert subvariety X′ in Gr(l, V). The indexing set of X′ is given by {m−l, m−l+2, m−l+3, . . . , m}. This divisor of Gr(l, V) is precisely the intersection of the image of the Plücker embedding (FIG. 3) with the hypersurface of [symbol] (∧^{l}V) that is given by the vanishing of the last coordinate variable with respect to [symbol] . This remark will be justified in Section 4.

### 2.4 Tsfasman-Serre Theorem

In this section, to simplify our notation and to be consistent with our references, we will denote by πₘ the q-analog of m+1, where q is a power of a prime number. In other words, we set

$${π}_{m} : = {[ m + 1 ]}_{q} = {[ \begin{matrix}m + 1 \\ 1\end{matrix} ]}_{q} .$$

If X is a variety defined over [symbol] _{q}, then by X( [symbol] _{q}) we will denote the set of [symbol] _{q}-rational points of X.

As we mentioned before in our discussion of the Grassmann varieties, πₘ is the cardinality of the projective space [symbol] ^{m}( [symbol] _{q}).

Theorem 2.15 Let P be a nonzero homogeneous polynomial of degree r from [symbol] _{q}[x₀, . . . , xₘ]. If r≤q+1, then

$$\vert \{ x ∈ {ℙ}^{m} ( {𝔽}_{q} ) : P ( x ) = 0 \} \vert \leq {rq}^{m - 1} + {π}_{m - 2} . \qquad ( 2.16 )$$

Let a₁, . . . , aᵣ be distinct elements of [symbol] _{q}. If r≤q, then it is easy to check that the polynomial

$${G}_{r} ( {x}_{0} , … , {x}_{m} ) : = ( {x}_{1} - {a}_{1} {x}_{0} ) … ( {x}_{1} - {a}_{r} {x}_{0} )$$

has exactly rq^{m-1}+πₘ₋₂ zeros in [symbol] ^{m}( [symbol] _{q}). Likewise, it is easy to check that the polynomial

$${g}_{r} ( {x}_{1} , … , {x}_{m} ) = ( {x}_{1} - {a}_{1} ) … ( {x}_{1} - {a}_{r} ) ,$$

has exactly rq^{m-1} zeros in [symbol] ^{m}( [symbol] _{q}). It is well-known that this is the maximum of the number of [symbol] _{q}-rational points on a hypersurface of degree r in [symbol] ^{m}( [symbol] _{q}).

### 3. Some Helpful Lemmas

In this section, K denotes a finite field with q elements; all of our algebraic groups are defined over K.

Let s denote

$$( \begin{matrix}m \\ l\end{matrix} ) - 1 ,$$

and let {F₁, . . . , Fₛ₊₁} denote the standard basis for ∧^{l}V; if r∈{1, . . . , s+1} corresponds to the subset

$$I = \{ {i}_{1} , … , {i}_{l} \} ∈ ( \begin{matrix}[ m ] \\ l\end{matrix} ) ,$$

then Fᵣ is given by Fᵣ=eᵢ_{₁}∧ . . . ∧eᵢ_{ₗ}. Let x₁, . . . , xₛ₊₁ denote the corresponding Plücker coordinate functionals on ∧^{l}V. Thus, xᵣ=F*ᵣ for r∈{1, . . . , r+1}. Then the coordinate functionals on [symbol] (∧^{l}V⊗∧^{l}V) are given by xᵢ⊗xⱼ, i, j∈{1, . . . , s+1}.

As we mentioned before, we know from Nogin's work that the minimum distance on Gr(l, V) is given by

$$d = \vert \{ M ∉ {H}_{v} : M ∈ G r ( l , V ) \} \vert = {q}^{l ( m - l )} , \qquad ( 3.1 )$$

where v is any completely decomposable vector from ∧^{m-l}V≅(∧^{l}V)*, and Hᵥ is the hypersurface defined by Hᵥ={w∈∧^{l}V: w∧v=0} (see). Here, a vector v∈∧^{m-l}V is said to be completely decomposable if there exist m−l vectors u₁, . . . , uₘ₋ₗ∈V such that v=u₁∧ . . . ∧uₘ₋ₗ. It is easy to check that the Plücker coordinate functions are completely decomposable. In the sequel, we will not distinguish between ∧^{m-l}V and (∧^{l}V)*.

We set v to be the last Plücker coordinate function with respect to [symbol] , that is, v:=xₛ₊₁. Let us write [Hᵥ] for the projectivization of Hᵥ, that is, the image of Hᵥ under the canonical projection (∧^{l}V)\{0}→ [symbol] (∧^{l}V). Then [Hᵥ]∩Gr(l, V) is the unique Schubert divisor of Gr(l, V). Thus, we have the following alternative description of d:

$$\begin{matrix}d = \vert \{ M ∈ Gr ( l , V ) : {x}_{s + l} ( M ) \neq 0 \} \vert \\ = {( \begin{matrix}m \\ l\end{matrix} )}_{q} - \vert \{ M ∈ Gr ( l , V ) : {x}_{s + 1} ( M ) = 0 \} \vert .\end{matrix} \qquad ( 3.2 )$$

It follows from our discussion in Subsection 2.3 that d is the number of K-rational points on the open the subset {M∈Gr(l, V): xₛ₊₁(M)≠0}. From a similar vein, we will compute the minimum distance of the embedding Gr(l, V) [symbol] [symbol] (H⁰(rω̅ₗ)*). The main “novel ingredient” of our computation is the fact that the geometry of a higher twisting of the Plücker embedding is essentially determined by the cellular decomposition of the relevant projective space.

The action of GLₘ on V induces an action on ∧^{l}V. Let λ: [symbol] ₘ→Tₘ denote the one-parameter subgroup defined by

$$λ ( t ) = diag ( {t}^{{v}_{0}} , … , {t}^{{v}_{n - 1}} ) , \qquad ( 3.3 )$$

where v₀, . . . , vₘ₋₁ are integers such that vᵢ=2^{v}^{ᵢ₊₁} for i∈{0, . . . , m−2}. By λ, we get an action of [symbol] ₘ on [symbol] (∧^{l}V):

$$t \cdot [ A ] : = [ λ ( t ) \cdot A ] ( t ∈ {𝔾}_{m} , A ∈ {∧}^{l} V ) . \qquad ( 3.4 )$$

The notation [A] indicates that we are taking the image of the vector A under the projection ∧^{l}V\{0}→ [symbol] (∧^{l}V). This should not be confused with [m], which stands for the set {1, . . . , m}. We trust that this clash of notation will not cause any confusion for the reader.

Lemma 3.5. The fixed point set of the action of [symbol] ₘ is given by [symbol] (∧^{l}V) [symbol] ={[F₁], . . . , [Fₛ₊₁]}.

Let [(a₀, . . . , aₛ)] be a point in [symbol] (∧^{l}V), and let t∈ [symbol] ₘ. Then we have

$$t \cdot [ ( {a}_{0} , … , {a}_{s} ) ] = [ ( {t}^{{Σ}_{i = 0}^{l - 1} {v}_{i}} {a}_{0} , … , {t}^{{Σ}_{i = m - l}^{m - 1} {v}_{i}} {a}_{s} ) ] ( t ∈ {𝔾}_{m} ) .$$

The way that we chose the positive integers v₀, . . . , vₘ₋₁ ensures that the exponents of t in on the right hand side of (3.6) are strictly decreasing from left to right. It follows that

$$[ ( {a}_{0} , … , {a}_{s} ) ] \neq [ ( {t}^{{Σ}_{i = 0}^{l - 1} {v}_{i}} {a}_{0} , … , {t}^{{Σ}_{i = m - l}^{m - 1} {v}_{i}} {a}_{S} ) ] , \qquad ( 3.6 )$$

unless all but one of the coordinates is zero. Therefore, the fixed point set of the [symbol] ₘ-action is given by {[(1,0, . . . , 0)], [(0,1,0, . . . , 0)], . . . , [(0, . . . , 0,1)]}, which is precisely our standard basis {F₁, . . . , Fₛ₊₁}.

For i∈{1, . . . , s+1}, the subvariety

$${F}_{i}^{+} : = \{ ( {a}_{1} , … , {a}_{i} , 1 , 0 , … , 0 ) : {a}_{1} , … , {a}_{i} ∈ K \} ⊂ ℙ ( {∧}^{l} V ) \qquad ( 3.7 )$$

is called the plus-cell corresponding to Fᵢ; it is isomorphic to the affine space Kⁱ. Since [symbol] (∧^{l}V)=␣ᵢ₌₀^{m}Fᵢ⁺, the plus-cell decomposition is a cellular decomposition of [symbol] (∧^{l}V) in the sense of algebraic topology.

Clearly, the Grassmann variety Gr(l, V) in [symbol] (∧^{l}V) is stable under the action (3.4), and furthermore, every fixed point of λ is contained in Gr(l, V). It follows that the intersections of the plus-cells (3.7) with Gr(l, V) gives the plus-cell decomposition of Gr(l, V).

Next, we will prove that this plus-cell decomposition of the Grassmann variety agrees with its Bruhat-Chevalley decomposition, (2.12).

Lemma 3.8 Let r∈{0, . . . , s} correspond to the subset I∈

$$( \begin{matrix}[ m ] \\ l\end{matrix} )$$

with respect to [symbol] . Then Fᵣ⁺∩Gr(l, V) is equal to the Schubert cell C_{I}.

The Plücker embedding is a GLₘ-equivariant morphism. Let Bₘ denote the Borel subgroup of upper triangular matrices in GLₘ. On one hand we have that C_{I} is the Bₘ-orbit of Fᵣ. On the other hand, we see that the Bₘ-orbit of [(0, . . . ,0,1,0, . . . ,0)], where 1 appears in the r-th position, is given by Fᵣ⁺. Indeed, the action of Bₘ on [symbol] (∧^{l}V) is obtained from the first fundamental representation of GLₘ on V≅K^{m}, whereby, Bₘ·eᵣ= [symbol] e₁, . . . , eᵣ [symbol] . Since the nonzero Plücker coordinate functions on Fᵣ⁺ are the ones that correspond to the l-subsets J∈

$$( \begin{matrix}[ m ] \\ l\end{matrix} )$$

such that J [symbol] I, we see the Bₘ-orbit of Fᵣ in [symbol] (∧^{l}V) is contained in Fᵣ⁺. In particular, we see that Fᵣ⁺∩Gr(l, V)=Bₘ·Fᵣ. This finishes the proof of our lemma.

The unique Schubert divisor X_{{m-l,m-l+2, . . . , m}} is equal the intersection of Gr(l, V) with the hypersurface {xₛ₊₁=0} of [symbol] (∧^{l}V).

As we already pointed out above, the uniqueness of the one-codimensional Schubert subvariety is easy to check from the Bruhat-Chevalley order (2.13). The Plücker coordinate function xₛ₊₁ corresponds to the subset {m−l+1, . . . , m} which is maximal with respect to [symbol] . In other words, by Lemma 3.8, {xₛ₊₁≠0}∩Gr(l, V) is the open Schubert cell in Gr(l, V). Therefore, its complement, also called the boundary, is Bₘ-stable. In particular, the boundary of the open cell is a union of Schubert subvarieties. Since there is a unique codimension one Schubert subvariety (hence, all other proper Schubert subvarieties are contained in this one), the boundary is equal to X_{{m-l,m-l+2, . . . , m}} as claimed. But the complement is equal to the intersection {xₛ₊₁=0}∩Gr(l, V). This finishes the proof of our claim.

### 4. The Main Theorem

Recall that the dimension of an algebraic geometric [n, k, d]_{q}-code C on a projective variety X [symbol] [symbol] ^{r} is given by the “dimension” of the image of the evaluation map ev: E*→ [symbol] _{q}ⁿ, that is, l=m−dimker(ev). Here, we view E* as the vector space homogeneous linear forms on [symbol] ^{r}= [symbol] (E). If the projective embedding of X is E is an equivariant embedding with respect to an action of an affine group G, then the kernel of the evaluation map has the structure of a finite dimensional G-module. In the case of Grassmann codes that we discussed earlier, the Plücker embedding of Gr(l, V) is given by the SLₘ-representation ∧^{l}V, which is well-known to be a simple SLₘ-module, hence, the corresponding evaluation map is injective. This is essentially the reason why one does not need to mention anything further about l; it is simply the dimension of the irreducible representation ∧^{l}V. However, for all other projective embeddings of Gr(l, V), the kernel of the evaluation map is not trivial since the corresponding SLₘ-module may not be simple. In general, the simpleness of the corresponding Weyl module strongly depends on the characteristic of the base field [symbol] _{q}.

We are now ready to prove our main theorem.

Theorem 4.1. Let C denote the projective [n, k, d]-system associated with the closed embedding obtained from the composition

$$ι : Gr ( l , V ) \to ℙ ( {\prod }^{r} ( {∧}^{l} V ) ) \to ℙ ( {( {∧}^{l} V )}^{⊗ r} ) .$$

Then the parameters of C satisfy

$$1. \qquad n = {[ \begin{matrix}m \\ l\end{matrix} ]}_{q} ,$$

$$2. \qquad {q}^{l ( m - l )} - r {q}^{l ( m - l ) - 1} \leq d \leq {q}^{l ( m - l )} - ( r - 1 ) {q}^{l ( m - l ) - 1} ,$$

$$\begin{matrix}3. & dim {soc}_{{SL}_{m}} ( {H}^{0} ( r {\overline{ω}}_{l} ) ) \leq k \leq d i m {H}^{0} ( r {\overline{ω}}_{l} ) ,\end{matrix}$$

where soc_{SL}_{ₘ}H⁰(rω̅ₗ) is the unique simple submodule of H⁰(rω̅ₗ). Moreover, the upper bound for k is achieved if H⁰(rω̅ₗ) is a simple SLₘ-module.

Before we give the proof of our main theorem, we have the following observations.

First, let us point out that if the characteristic of the underlying field is big enough, then H⁰(rω̅ₗ) is a simple SLₘ-module. In this case, we have k=dimH⁰(rω̅ₗ). As we will show in the sequel, the dimension of H⁰(r1̅0̅7̅ ₗ) can be calculated by the well-known Weyl dimension formula. These observations show that Theorem 1.3 follows from Theorem 4.1 when p is sufficiently big.

Secondly, even if H⁰(rω̅ₗ) is not simple, in lower ranks, the formal character of soc_{SL}_{ₙ}(H⁰(rω̅ₗ)), hence its dimension, are not so difficult to compute.

By our discussion from Subsection 2.2, the image of ι is contained in the projective subspace [symbol] (H⁰(rω̅ₗ)*) in [symbol] ((∧^{l}V)^{⊗r}); for r=2, the corresponding embedding of Gr(l, V) is explicitly given by the assignment (2.4). The case of an arbitrary r∈ [symbol] is a straightforward generalization of this special case. Also, we already know that the number of [symbol] _{q}-rational points of Gr(l, V) is

$${[ \begin{matrix}m \\ l\end{matrix} ]}_{q} .$$

This is the length of our code. We now proceed to compute the minimum distance.

Let [symbol] (1) denote the first Serre twist of the structure sheaf of [symbol] ((∧^{l}V)^{⊗r}). The pullback of this line bundle under the Segre embedding is equal to the r-fold tensor product [symbol] (1) [symbol] . . . [symbol] [symbol] (1). The restriction of this product to the diagonal, which is isomorphic to [symbol] (∧^{l}V), is given by the multiplication of the sections of the factors; it lands in [symbol] (r). Therefore, we notice that a degree one hypersurface in [symbol] ((∧^{l}V)^{⊗r}) determines a degree r hypersurface in [symbol] (∧^{l}V). Since our goal is to compute the minimum distance, we will work with the hypersurfaces in [symbol] ((∧^{l}V)^{⊗r}) having the highest number of [symbol] _{q}-rational points. Therefore, we will consider the following degree r polynomial:

$$( 4.3 )$$

$$P := {x}_{s + 1} ( {x}_{s + 1} - {b}_{1} {x}_{s} ) … ( {x}_{s + 1} - {b}_{r - 1} {x}_{s} ) ∈ {𝔽}_{q} [ {x}_{{i}_{1}} … {x}_{{i}_{r}} : 1 \leq {i}_{1} \leq … \leq {i}_{r} \leq s + 1 ] ,$$

where b₁, . . . , bᵣ₋₁ are distinct nonzero elements of [symbol] _{q}. In particular, the number of [symbol] _{q}-rational points of the hypersurface U_{P}:={P=0} in [symbol] (∧^{l}V) is equal to rq^{s-1}+πₛ₋₂.

Next, we intersect U_{P} with the Grassmann Gr(l, V); we will determine the number of [symbol] _{q}-rational points of the intersection. In other words, we want to determine the number

$$\vert \{ M ∈ Gr ( l , V ) : ( {x}_{s + 1} ( {x}_{s + 1} - {b}_{1} {x}_{s} ) … ( {x}_{s + 1} - {b}_{r - 1} {x}_{s} ) ) ( M ) = 0 \} \vert . \qquad ( 4.4 )$$

We split our analysis of the defining equation in (4.4) into three major cases:

$$1. \qquad {x}_{s + 1} ( M ) = {x}_{s} ( M ) = 0 and M ∈ Gr ( l , V ) ;$$

$$2. \qquad {x}_{s + 1} ( M ) = 0 , {x}_{s} ( M ) \neq 0 and M ∈ Gr ( l , V ) ;$$

$$3. \qquad {x}_{s + 1} ( M ) \neq 0 , ( ( {x}_{s + 1} - {b}_{1} {x}_{s} ) … ( {x}_{s + 1} - {b}_{r - 1} {x}_{s} ) ) ( M ) = 0 , and M ∈ Gr ( l , V ) .$$

In the first case, that is {M∈ [symbol] (∧^{l}V): xₛ₊₁(M)=xₛ(M)=0}∩Gr(l, V), we get every point M from Gr(l, V) which is not contained in the Schubert cells of codimension ≤1. Since Gr(l, V) has a unique Schubert divisor, we see that

$$\{ M ∈ ℙ ( {∧}^{l} V ) : {x}_{s + 1} ( M ) = {x}_{s} ( M ) = 0 \} ∩ Gr ( l , V ) \vert [ \begin{matrix}m \\ l\end{matrix} ] - {q}^{l} \text{?} - {q}^{l ( m - l ) - 1} .$$

$$\text{?} \text{indicates text missing or illegible when filed}$$

In the second case, we get precisely the codimension one Schubert cell in Gr(l, V), which has q^{l(m-l)-1} elements. Finally, in the third case, the intersection

$$\{ M ∈ ℙ ( {∧}^{l} V ) : {x}_{s + 1} ( M ) \neq 0 , ( ( {x}_{s + 1} - {b}_{1} {x}_{s} ) … ( {x}_{s + 1} - {b}_{r - 1} {x}_{s} ) ) ( M ) = 0 \} ∩ Gr ( l , V )$$

is a hypersurface in the dense Bruhat cell of Gr(l, V). Since the defining equation of this hypersurface is given by (xₛ₊₁(M)−b₁xₛ) . . . (xₛ₊₁(M)−bᵣ₋₁xₛ)=0, where xₛ₊₁(M)≠0, and bᵢ's are distinct elements from [symbol] _{q}, this hypersurface has exactly (r−1)q^{l(m-l)-1} [symbol] _{q}-rational points. Thus, we see that the total number of zeros of the homogeneous polynomial xₛ₊₁(xₛ₊₁−b₁xₛ) . . . (xₛ₊₁−bᵣ₋₁xₛ) on Gr(l, V) is given by

$$( {[ \begin{matrix}m \\ l\end{matrix} ]}_{q} - {q}^{l ( m - l )} - {q}^{l ( m - l \} - 1} ) + {q}^{l ( m - l \}} + ( r - 1 ) {q}^{l ( m - l ) - 1} = {[ \begin{matrix}m \\ l\end{matrix} ]}_{q} - {q}^{l ( m - l )} + ( r - 1 ) {q}^{l ( m - l ) - 1} .$$

It follows that an upper bound for the minimum distance on Gr(l, V) in [symbol] ((∧^{l}V)^{⊗r}) is given by

$${[ \begin{matrix}m \\ l\end{matrix} ]}_{q} - ( {[ \begin{matrix}m \\ l\end{matrix} ]}_{q} - {q}^{l ( m - l )} + ( r - 1 ) {q}^{l ( m - l ) - 1} ) = {q}^{l ( m - l )} - ( r - 1 ) {q}^{l ( m - l ) - 1} . \qquad ( 4.5 )$$

Next, we will prove our formula for the lower bound for the minimum distance. To this end, let Q be a homogeneous degree r polynomial from [symbol] _{q}[x₁, . . . , xₛ₊₁] such that the intersection H_{Q}∩Gr(l, V) attains the maximum number of [symbol] _{q}-rational points among all such intersections. Here, H_{Q} denotes the hypersurface in [symbol] (∧^{l}V) defined by Q. It follows that the intersection of H_{Q} with the open cell of Gr(l, V) is nonempty. We assume that this intersection attains the maximum number rq^{l(m-l)-1}. Under these assumptions, we see that

$${\vert {H}_{Q} ∩ Gr ( l , V ) \vert}_{{𝔽}_{q}} \leq {rq}^{l ( n - l ) - 1} + [ \begin{matrix}m \\ l\end{matrix} ] - {q}^{l ( m - l )} , \qquad ( 4.6 )$$

where

$${[ \begin{matrix}m \\ l\end{matrix} ]}_{q} - {q}^{l ( m - l )}$$

is the number of [symbol] _{q}-rational points in the complement of the open cell in the Grassmannian. Since (4.6) is an upper bound for the number of zeros of Q on Gr(l, V) over [symbol] _{q}, a lower bound for the minimum distance is given by

$${[ \begin{matrix}m \\ l\end{matrix} ]}_{q} - ( {[ \begin{matrix}m \\ l\end{matrix} ]}_{q} - {q}^{l ( m - l )} + {rq}^{l ( m - l ) - 1} ) = {q}^{l ( m - l )} - {rq}^{l ( m - l ) - 1} . \qquad ( 4.7 )$$

By combining (4.5) and (4.7), we obtain the following inequalities for the minimum distance,

$${q}^{l ( m - l )} - r {q}^{l ( m - l ) - 1} \leq d \leq {q}^{l ( m - l )} - ( r - 1 ) {q}^{l ( m - l ) - 1} . \qquad ( 4.8 )$$

It remains to compute the dimension of our code. Since the image of [symbol] is contained in [symbol] ((H⁰(Gr(l, V), [symbol] (rω̅ₗ))*), the image of the evaluation map ev: ((∧^{l}V)^{⊗r})*→ [symbol] _{q}ⁿ agrees with the image of the (restricted) evaluation map ev: H⁰(rω̅ₗ)*→ [symbol] _{q}ⁿ. On one hand, if H⁰(rω̅ₗ) is a simple SLₘ-module, then so is H⁰(rω̅ₗ)*. In this case, the kernel of the evaluation map is trivial, hence, k=dimH⁰(rω̅ₗ). On the other hand, if our finite dimensional module H⁰(rω̅ₗ) is not simple, then it is not guaranteed that the kernel of the evaluation map is trivial. Nevertheless, it is always true that the sum of all simple submodules, namely, the socle of H⁰(rω̅ₗ), is not contained in the kernel. Indeed, it is well-known that soc_{SL}_{ₘ}H⁰(rω̅ₗ) is simple, so, if it were contained in the kernel, then the evaluation map has to map the whole vector space to 0, which would be absurd. This argument shows that the dimension of the evaluation map is at least as big as dimsoc_{SL}_{ₘ}H⁰(rω̅ₗ). Hence, the proof of our assertion is finished.

We conclude this subsection by a remark that expands on the last part of the proof of our Theorem 4.1. Let λ denote the (dominant) weight rω̅ₗ. We assume that H⁰(λ) is a simple SLₘ-module. Then, as we pointed out above, the Weyl module V(λ) is isomorphic to H⁰(λ). Since V(λ) is generated, as an SLₘ-module, by a B-stable line of weight λ, we see that the SLₘ-orbit of a nonzero vector in the socle of H⁰(λ)* generates the whole module. In our case, the SLₘ-orbit of a nonzero vector on such a line is isomorphic to Gr(l, V). Thus, the projective space on H⁰(λ)* is spanned by the image of the embedding of our Grassmann variety.

### 4.1 Weyl's Character and Dimension Formulas

Let λ=rω̅ₗ (r∈ [symbol] ) be a dominant weight for SLₘ. As we mentioned before, assuming that H⁰(rω̅ₗ) is simple, its character and dimension can be computed as if we are working over the field of complex numbers. In particular, in this case we can apply the well-known combinatorics of Young tableaux. The purpose of this subsection is to briefly explain how this methodology works. A general reference for this material is.

Recall that the monoid of dominant weights for (SLₘ, Bₘ, Tₘ) is generated by the fundamental weights ω̅ᵢ (1≤i≤m−1). Let a₁ω̅₁+ . . . +aₘ₋₁ω̅ₘ₋₁∈X(Tₘ)₊ be a dominant weight for some nonnegative integers aᵢ∈ [symbol] (1≤i≤m−1), and set λₘ:=0. Then the sequence λ=(λ₁, . . . , λₘ) defined by the equations,

$${λ}_{i} - {λ}_{i + 1} = {a}_{i} for i ∈ [ m - 1 ]$$

is an integer partition, that is, λ₁≥λ₂≥ . . . ≥λₘ. Clearly, if we are given λ, then we can solve these equations for aᵢ's as well. In other words, there is a one-to-one correspondence between the integer partitions and the dominant weights for the special linear groups. In light of this bijection, a₁ω̅₁+ . . . +aₘ₋₁ω̅ₘ₋₁ [symbol] λ, hereafter, for the sake of brevity, let us denote by W(λ) the simple module H⁰(Gr(l, V), [symbol] (a₁ω̅₁+ . . . +aₘ₋₁ω̅ₘ₋₁))*.

Let λ=(λ₁, . . . , λₘ) be an integer partition. Recall that the Young diagram of λ is a top-left justified arrangement of the boxes with λᵢ boxes in the i-th row. A semistandard Young tableau of shape λ (or an SSTY of shape λ, for short) is a filling of the boxes of the Young diagram of shape λ with positive integers that is weakly increasing in every row and strictly increasing in every column. For example, in FIG. 5, we have an SSYT of shape (5,4,4).

Let T be an SSYT of shape λ. Let us define the weight of T as the monomial x^{T}:=xᵢ_{₁}ⁿ^{₁} . . . xᵢ_{ₖ}ⁿ^{ₖ}, where the integer iⱼ (1≤j≤k) appears in T nⱼ times. Then the character of a simple SLₘ ( [symbol] )-module W(λ) is given by the Schur function s_{λ}(x₁, . . . , xₘ) which is defined as the weight generating function of all SSYT of shape λ,

$${s}_{λ} ( {x}_{1} , … , {x}_{m} ) = {\sum }_{T : SSTY of shape λ} {x}^{T} .$$

In particular, by specializing the variables xᵢ (1≤i≤n) to 1, we get the dimension of W(λ),
dimW(λ)=#SSYT of shape λ filled with entries from {1, . . . , m}.

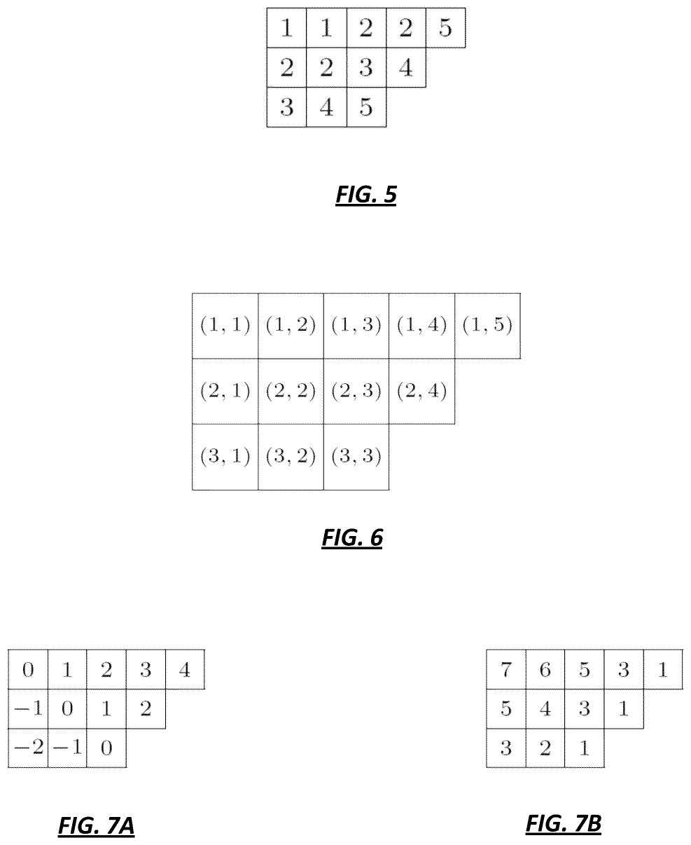

This number can be calculated in a combinatorial way by the hook length formula. To explain this formula, we first put coordinates on the boxes of the Young diagram of λ=(λ₁, . . . , λₘ) by identifying it with the set {(i, j): j∈[λᵢ], i∈[m]}. For example, the coordinates of the integer partition (5,4,3) are depicted in FIG. 6.

The content of a box u=(i, j) in the Young diagram of λ is defined as c(u):=j−i. The hook length of u, denoted by h(u) is defined as the number of boxes directly to the right of u and directly below u, counting u itself once. The diagram on the left (FIG. 7A) shows the contents and the diagram on the right (FIG. 7B) shows the hook lengths of the boxes of λ.

In this notation we have the following concrete form of the Weyl's dimension formula,

$${s}_{λ} ( 1 , … , 1 ) = {\prod }_{u ∈ Young diagram of λ} \frac{m + c ( u )}{h ( u )} . \qquad ( 4.9 )$$

Let V be a three dimensional vector space over [symbol] . Let l=2. In this case, the partition corresponding to the dominant weight ω̅ₗ is λ=(1,1), and therefore, we have the following SSYT tableaux for the irreducible representation W(λ)≅H⁰(Gr(2, V), [symbol] (ω̅₂)):

| | | |
|---|---|---|
| 1 | 1 | 2 |
| 2 | 3 | 3 |

Note that, corresponding to each SSYT of shape λ, there is a Plücker coordinate function. For the tableaux in the above example, the Plücker coordinate functions are given by p₁₂, p₁₃, and p₂₃. In particular, we have

$$dimW ( λ ) = d i m {H}^{0} ( G r ( 2 , V ) , ℒ ( {ϖ}_{2} ) ) = 3 .$$

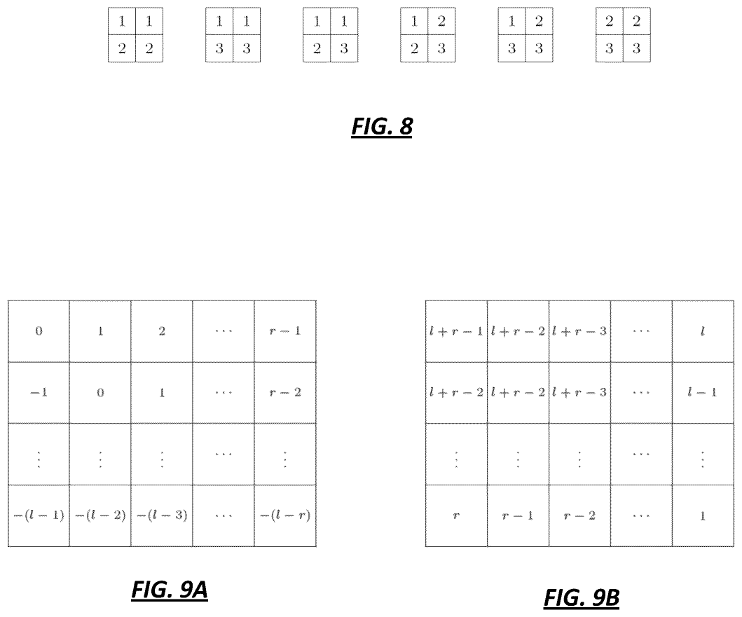

The partition corresponding to 2ω̅₂ is given by λ=(2,2). Thus, the SSYT's corresponding to the “Plücker coordinates” of the embedding for the line bundle [symbol] (2ω̅₂) are listed in FIG. 8. In particular, we see that H⁰(Gr(2, [symbol] ³), [symbol] (2ω̅₂)) is six dimensional. Of course, we can get the same count by using formula in (4.9).

Before we describe an application of this combinatorics to our main theorem, let us point out, by our running example, that for every sufficiently big characteristic p>0, the SLₘ( [symbol] _{q})-module H⁰(rωₗ) is simple.

For SL₃, ρ denotes ω̅₁+ω̅₂. Then 2ω̅₂+ρ=ω̅₁+3ω̅₂. By definition, the fundamental dominant weight ω̅ᵢ is the dual of the coroot αᵢ^{V}. Therefore, we have

$$〈 {ϖ}_{1} + 3 {ϖ}_{2} , {α}_{1}^{V} 〉 = 1 ,$$

$$〈 {ϖ}_{1} + 3 {ϖ}_{2} , {α}_{2}^{V} 〉 = 3 ,$$

$$〈 {ϖ}_{1} + 3 {ϖ}_{2} , {( {α}_{1} + {α}_{2} )}^{V} 〉 = 4 .$$

For every prime characteristic p≥5, the SL₃ (F_{q})-module W(λ) is simple.

Corollary 4.13 For every sufficiently big prime characteristic p, the dimension of the code C defined in Theorem 4.1 is given by

$$d i m {H}^{0} ( r {ϖ}_{l} ) = \frac{{\prod }_{i = 0}^{l - 1} {( m - i )}^{( r )}}{{\prod }_{i = 1}^{l} {( i )}^{( r )}} . \qquad ( 4.14 )$$

We know that for every sufficiently big prime characteristic, the SLₘ-module H⁰(rωₗ) is simple. Theorem 4.1 implies that the dimension of our code is given by the Weyl's dimension formula. The integer partition λ=(λ₁, . . . , λₘ) that corresponds to the dominant weight rω̅ₗ is given by

$${λ}_{1} = … = {λ}_{l} = r and {λ}_{j} = 0 for j ∈ \{ l + 1 , … , m \} .$$

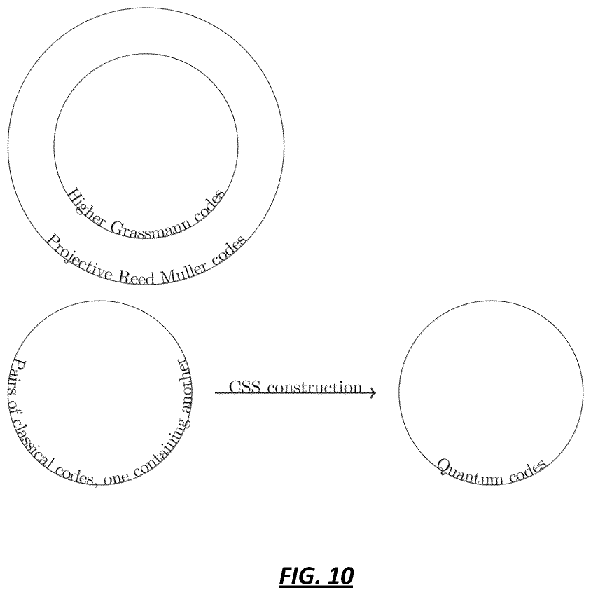

The contents and the hook lengths of the boxes of λ are depicted in FIGS. 9A and 9B.

To finish the proof, we will use the formula in (4.9) by using the content and hook length tableaux that are shown in (4.5). To keep track of the products, we multiply the entries row-by-row, from top-to-bottom. We multiply the entries of the rows of the content tableau from left-to-right:

$$Row 1 : m \cdot ( m + 1 ) … ( m + r - 1 ) = {m}^{( r )} ,$$

$$Row 2 : ( m - 1 ) \cdot m … ( m + r - 2 ) = {( m - 1 )}^{( r )} ,$$

$$⋮$$

$$Row \vert : ( m - ( l - 1 ) ) \cdot ( m - ( l - 2 ) ) … ( m - ( l - r ) ) = {( m - ( l - 1 ) )}^{( r )} .$$

Thus, the numerator of the hook length formula is given by Πᵢ₌₀^{l-1}(m−i)^{(r)}. For the hook length tableau, we multiply the entries of the rows from right-to-left:

$$Row 1 : l \cdot ( l + 1 ) … ( l + r - 1 ) = {l}^{( r )} ,$$

$$Row 2 : ( l - 1 ) \cdot l … ( l + r - 2 ) = {( l - 1 )}^{( r )} ,$$

$$⋮$$

$$Row \vert : 1 \cdot 2 … r = {( 1 )}^{( r )} .$$

Then the denominator of the hook length formula is given by Πᵢ₌₀^{l-1}(1+i)^{(r)}. This finishes the proof of our corollary.

We choose a sufficiently large prime characteristic p so that H⁰(rωₗ) is a simple SLₘ-module. Then the dimension k of our code is equal to dimH⁰(rωₗ). Hence, our theorem follows from Theorem 4.1 and Corollary 4.13.

We consider the embedding associated with the highest weight 2ω̅₃ of the Grassmann variety Gr(3, [symbol] _{q}⁵), where the characteristic of [symbol] _{q} is sufficiently large so that H⁰(2ω̅₃) is a simple SL₅-module. Then the parameters of our code are given by

$$n = {[ \begin{matrix}5 \\ 3\end{matrix} ]}_{q} = \frac{{{{[ 5 ]}_{q} [ 4 ]}_{q} [ 3 ]}_{q}}{{{{[ 3 ]}_{q} [ 2 ]}_{q} [ 1 ]}_{q}} = 1 + q + 2 {q}^{2} + 2 {q}^{3} + 2 {q}^{4} + {q}^{5} + {q}^{6} ,$$

$$k = \frac{{5}^{( 2 )} {4}^{( 2 )} {3}^{( 2 )}}{{1}^{( 2 )} {2}^{( 2 )} {3}^{( 2 )}} = \frac{5 \cdot 6 \cdot 4 \cdot 5 \cdot 3 \cdot 4}{1 \cdot 2 \cdot 2 \cdot 3 \cdot 3 \cdot 4} = 50 ,$$

$$and$$

$${q}^{6} - 2 {q}^{5} \leq d \leq {q}^{6} - {q}^{5} .$$

Note that, if q>3, then n−d is significantly bigger than k=50.

Construction of Quantum Error correcting codes from Higher Grassmann codes

We first extend the Higher Grassmann codes to the case where the degree v of the polynomials is no longer bounded above by q, but by (q−1)l(m−l). This is necessary for the construction of quantum codes. Then we obtain the following extensions of the results considered earlier and these are discussed in the sequel to the original paper that also has been accepted for publication in the same journal.

Theorem 0.1 The dimension of the higher Grassmann code on Gr(F_{q}) of degree ν, where 0≤ν<(q−1)l(m−l), is given by the formula:

$${dimC}_{G r} ( {F}_{q} ) ( ν ) = {\sum }_{\begin{matrix}0 \leq t \leq ν \\ t ≡ ν modq - 1\end{matrix}} {\sum }_{r = 1}^{min \{ t , 1 ( m - l ) \}} h ( r , m , l ) g ( t , r , q - 1 ) ,$$

$$where$$

$$h ( r , m , l ) = {\sum }_{c = 0}^{r} {( - 1 )}^{r - c} {r}_{c} {\prod }_{i = 1}^{m - l} {\prod }_{j = 1}^{c} {\prod }_{s = 1}^{m - l} \frac{i + j + s - 1}{i + j + s - 2} ,$$

$$and$$

$$g ( t , r , q - 1 ) = {\sum }_{j = 0}^{⌊ \frac{t - r}{q - 1} ⌋} {( - 1 )}_{j}^{{i}_{r}} t - 1 - ( q - 1 ) {j}_{r - 1} .$$

Theorem 0.2 Let 0≤ν≤(q−1)l(m−l)−1. If μ is defined by the equation μ:=(q−1)(l(m−l)−1)−ν, then the dual of C_{Gr(F}_{_{q}}₎(ν) is given by one of the following two cases:

$${{C}_{G r ( {F}_{q} )} ( ν )}^{⊥} = \{ \begin{matrix}{C}_{G r ( {F}_{q} )} ( μ ) & if ν \neq 0 mod ( q - 1 ) , \\ \overline{{C}_{G r ( {F}_{q} )} ( μ )} & if ν = 0 mod ( q - 1 )\end{matrix} .$$

where C_{Gr(F}_{_{q}}₎(μ) is the code obtained from C_{Gr(F}_{_{q}}₎(μ) by adding the code word that is 1 everywhere.

Theorem 0.3 Let C_{Gr(l,v)}(ν) denote the q-ary degree ν Higher Grassmann code on Gr(l, V). Let r and s denote non-negative integers defined by ν−1=r(q−1)+s, where 0≤s<q−1. If ν<(q−1)l(m−ł), then the minimum distance of C_{Gr(l,V)}(ν) is bounded as follows:

$$( q - s ) {q}^{ł ( m - l ) - r - 1} \leq d \leq ( q - 1 - s ) {q}^{l ( m - 1 ) - r - 1} .$$

We will next outline two different constructions of quantum error correcting codes based on the higher Grassmann codes. The construction of quantum codes from these Projective Reed-Muller codes has been well understood at least for over a decade. This invokes certain construction of quantum codes starting with a pair of classical codes, commonly referred to as the Calderbank-Shor-Steane construction. We proceed to discuss in some detail, how similar constructions apply to the Higher Grassmann codes to produce quantum codes. We will also point out that the resulting quantum codes have certain advantages over the quantum codes produced from the Projective Reed-Muller codes.

With reference to FIG. 10, a key idea of our construction of quantum codes from the Higher Grassmann codes is to first show that one can imbed the Higher Grassmann codes as sub-codes of the Projective Reed-Muller codes.

In a first construction we start with the Grassmann variety imbedded into a projective space using what is called the Plücker imbedding and follow it by imbedding the above projective space in a much larger projective space ( [symbol] ^{m}) as in our paper. This corresponds to the ample line bundle [symbol] (ν) on our Grassmann variety: in this construction we do not put any restriction on how large ν can be. Moreover we start with two line bundles [symbol] (ν₁) and [symbol] (ν₂), with ν₂=ν₁+k(q−1), where [symbol] _{q} denotes the finite field of cardinality q over which we choose to work and k>0 is an integer. The global sections of the above two line bundles correspond to homogeneous polynomials over [symbol] _{q} in m+1 variables of degrees ν₁ and ν₂, respectively. The corresponding higher Grassmann codes are obtained by evaluating these sections at the [symbol] _{q}-rational points on the Grassmann variety. We obtain two higher Grassmann codes this way, C_{Gr}(ν₁) and C_{Gr}(ν₂) with C_{Gr}(ν₁)⊆C_{Gr}(ν₂). Moreover the minimum distance of the code C_{Gr}(ν₂)−C_{Gr}(ν₁)≥the minimum distance of the code C_{Gr}(ν₂): further we have recently calculated the minimum distances of these higher Grassmann codes extending the calculations in which only handled the case where the degrees ν₁, and ν₂ were assumed to be no larger than q.

On applying the CSS construction to the two higher Grassmann codes, C_{Gr}(ν₁) and C_{Gr}(ν₂), we obtain quantum error correcting codes whose parameters are determined by the parameters of the higher Grassmann codes as follows: the length of the code will be the number of [symbol] _{q}-rational points on the Grassmannian, the dimension of the resulting quantum code is the difference of the dimensions of the two Grassmann codes C_{Gr}(ν₁) and C_{Gr}(ν₂), and the minimum distance is bounded below by the minimum of the minimum distance of the code C_{Gr}(ν₂) and the minimum distance of the code C_{Gr}(ν₁)^{⊥}.

Advantages of such quantum codes. First the dimensions of the higher Grassmann codes C_{Gr}(ν₁) and C_{Gr}(ν₂) are much larger (in fact, several times larger) than the corresponding Grassmann codes as the calculation of the dimension of the higher Grassmann codes in shows. In view of the calculation of the dimensions of the resulting quantum codes as above, this advantage also shows up in the dimensions of the resulting quantum codes. A comparison of the minimum distance of the higher Grassmann codes with the minimum distances of the corresponding Projective Reed-Muller code shows that the minimum distances for the higher Grassmann codes are typically much larger: this translates into much larger minimum distances for the resulting quantum codes as well. Moreover, larger dimensions and larger minimum distances translate into codes that perform much better.

Another advantage is that, as there is no restriction on the degrees ν₁ and ν₂, we obtain large families of quantum codes this way.

In a second construction we restrict to line bundles [symbol] (ν) so that 1≤ν≤└ [symbol] (m− [symbol] )(q−1)/2┘ and 2ν≡0 mod (q−1). Then our first observation is that corresponding higher Grassmann code C_{Gr}(ν) is self-dual. Moreover, in this case one can write ν^{⊥}= [symbol] (m− [symbol] )(q−1)−ν, as k(q−1)+ν, where k= [symbol] (m− [symbol] )−(2ν/(q−1)). Therefore, this fits into the framework of the first case with ν₁=ν and ν₂=ν^{⊥}= [symbol] (m− [symbol] )(q−1)−ν. The construction in 1, then produces quantum codes, whose length and dimension are as in case 1 above and where the minimum distance is given by the minimum distance of the dual code C_{Gr}(ν)^{⊥}. Note: it is again here that we need to determine the min distance of the duals of the higher Grassmann codes.

Advantages of the resulting quantum codes: These codes share several of the features of the quantum codes in 1, and hence their advantages.

### Implementation Details

We will start with a pair of Higher Grassmann codes, C₁ and C₂, with C₂ a subcode of C₁. Then denoting the parity check matrices for the codes C₁ and C₂ by H(C₁) and H(C₂), the resulting quantum code produced by invoking the CSS construction is a stabilizer code where the stabilizer matrix is given by

$$S = ( \begin{matrix}H ( {C}_{2}^{⊥} ) & 0 \\ 0 & H ( {C}_{1} )\end{matrix} ) ,$$

where H(C₁) (H(C₂^{⊥})) denotes the parity check matrix of the Higher Grassmann code C₁ (C₂^{⊥}), with C₂^{⊥} denoting the dual of the code C₂.

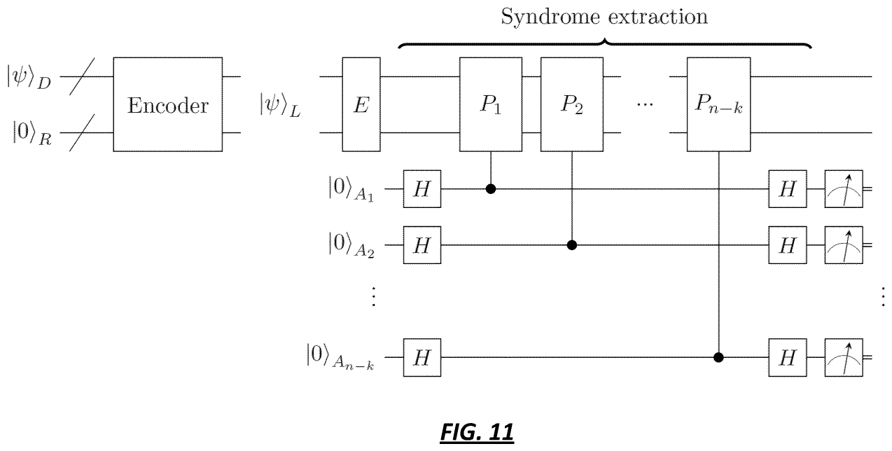

Therefore, it is possible to invoke the circuitry for encoding and decoding quantum stabilizer codes as shown in FIG. 11, which illustrates a circuit having a structure of an [[n; k; d]] stabilizer code. A quantum data register |ψ [symbol] _{D}=|ψ₁ψ₂ . . . ψₖ [symbol] is entangled with redundancy qubits |0 [symbol] _{R}=|0₁0₂ . . . 0ₙ₋ₖ [symbol] via an encoding operation to create a logical qubit |ψ [symbol] _{L}. After encoding, a sequence of n−k stabilizer checks Pᵢ are performed on the register, and each result copied to an ancilla qubit Aᵢ. The subsequent measurement of the ancilla qubits provides an m-bit syndrome.

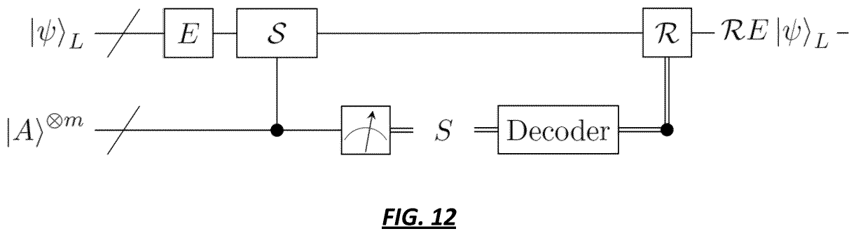

FIG. 12 illustrates a general procedure for active recovery in a quantum error correction code. The logical qubit |ψ [symbol] _{L} of an [[n, k, d]] stabilizer code is subject to an error process E. A generating set of stabilizers S are measured on the logical state to yield an m-bit syndrome [symbol] . This syndrome is processed by a decoder to determine the best recovery operation [symbol] to return the logical state to the codespace. After the recovery has been applied, the output of the error correction cycle is [symbol] E|ψ [symbol] _{L}. Double lines indicate classical information flow.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. The present disclosure is capable of other implementations and of being practiced or carried out in various ways.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary implementations include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example implementations, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

We claim:

1. An apparatus to encode and decode quantum [[n; k; d]] stabilizer codes, comprising:
an encoder that entangles a quantum data register |ψ [symbol] _{D}=|ψ₁ψ₂ . . . ψₖ [symbol] with redundancy qubits |0 [symbol] _{R}=|0₁0₂ . . . 0ₙ₋ₖ [symbol] to create a logical qubit |ψ [symbol] _{L}; and
stabilizer check logic that, after encoding, performs a sequence of n−k stabilizer checks Pᵢ on the quantum data register and that copies each result to an ancilla qubit Aᵢ,
wherein the subsequent measurement of the ancilla qubits provides an m-bit syndrome.

2. The apparatus of claim 1, wherein the redundancy qubits comprise higher Grassmann codes.

3. The apparatus of claim 2, wherein a Grassmann variety is imbedded into a projective space using Plücker imbedding that is imbedded in a higher-order projective space ( [symbol] ^{m}) that corresponds to line bundles [symbol] (ν) on the Grassmann variety.

4. The apparatus of claim 3, wherein there is a no restriction on how large ν is, wherein two line bundles [symbol] (ν₁) and [symbol] (ν₂) are used with ν₂=ν₁+k(q−1), wherein [symbol] _{q} denotes a finite field with q elements, where q is a power of a prime number, p and wherein k>0 is an integer.

5. The apparatus of claim 4, wherein the higher Grassmann codes are obtained by evaluating global sections of the two line bundles correspond to homogeneous polynomials over [symbol] _{q} in m+1 variables of degrees ν₁ and ν₂, respectively, at the [symbol] _{q}-rational points on the Grassmann variety.

6. The apparatus of claim 5, wherein two higher Grassmann codes, C_{Gr}(ν₁) and C_{Gr}(ν₂) with C_{Gr}(ν₁)⊆C_{Gr}(ν₂) are obtained, and
wherein a CSS construction is applied to the two higher Grassmann codes, C_{Gr}(ν₁) and C_{Gr}(ν₂) to obtain quantum error correcting codes whose parameters are determined by the parameters of the higher Grassmann codes as follows: the length of the code will be the number of [symbol] _{q}-rational points on the Grassmannian, the dimension of the resulting quantum code is the difference of the dimensions of the two Grassmann codes C_{Gr}(ν₁) and C_{Gr}(ν₂), and the minimum distance is bounded below by the minimum of the minimum distance of the code C_{Gr}(ν₂) and the minimum distance of the code C_{Gr}(ν₁)^{⊥}.

7. The apparatus of claim 3, wherein the line bundles [symbol] (ν) are restricted such that 1≤ν≤└ [symbol] (m− [symbol] )(q−1)/2┘ and 2ν≡0 mod (q−1).

8. The apparatus of claim 7, wherein the higher Grassmann codes C_{Gr}(ν) are self-dual.

9. The apparatus of claim 8, wherein ν^{⊥}= [symbol] (m− [symbol] )(q−1)−ν, as k(q−1)+ν, where k= [symbol] (m− [symbol] )−(2ν/(q−1)), and wherein a CSS construction is applied to the higher Grassmann codes, C_{Gr}(ν₁) and C_{Gr}(ν₂) to obtain quantum error correcting codes whose parameters are determined by the parameters of the higher Grassmann codes as follows: the length of the code will be the number of [symbol] _{q}-rational points on the Grassmannian, the dimension of the resulting quantum code is the difference of the dimensions of the two Grassmann codes C_{Gr}(ν₁) and C_{Gr}(ν₂), and the minimum distance is bounded below by the minimum of the minimum distance of the code C_{Gr}(ν₂) and the minimum distance of the code C_{Gr}(ν₁)^{⊥}.

10. A method to encode and decode quantum [[n; k; d]] stabilizer codes error correcting codes from higher Grassmann codes, comprising:
generating higher Grassmann codes that are imbedded as sub-codes of in a higher-order projective space ( [symbol] ^{m}) that corresponds to line bundles [symbol] (ν) on the Grassmann variety;
entangling a quantum data register |ψ [symbol] _{D}=|ψ₁ψ₂ . . . ψₖ [symbol] with redundancy qubits |0 [symbol] _{R}=|0₁0₂ . . . 0ₙ₋ₖ [symbol] that use the higher Grassmann codes to create a logical qubit |ψ [symbol] _{L};
performing a sequence of n−k stabilizer checks Pᵢ on the quantum data register and copying each result to an ancilla qubit Aᵢ; and
performing a subsequent measurement of the ancilla qubits to provide an m-bit syndrome.

12. The method of claim 11, further comprising placing no restrictions on how large ν is and using two line bundles [symbol] (ν₁) and [symbol] (ν₂) with ν₂=ν₁+k(q−1), wherein [symbol] _{q} denotes a finite field with q elements, where q is a power of a prime number, p and wherein k>0 is an integer.

13. The method of claim 12, further comprising obtaining the higher Grassmann codes by evaluating global sections of the two line bundles correspond to homogeneous polynomials over [symbol] _{q} in m+1 variables of degrees ν₁ and ν₂, respectively, at the [symbol] _{q}-rational points on the Grassmann variety.

14. The method of claim 13, wherein two higher Grassmann codes, C_{Gr}(ν₁) and C_{Gr}(ν₂) with C_{Gr}(ν₁)⊆C_{Gr}(ν₂) are obtained, and further comprising: applying a CSS construction to the two higher Grassmann codes, C_{Gr}(ν₁) and C_{Gr}(ν₂) to obtain quantum error correcting codes whose parameters are determined by the parameters of the higher Grassmann codes as follows: the length of the code will be the number of [symbol] _{q}-rational points on the Grassmannian, the dimension of the resulting quantum code is the difference of the dimensions of the two Grassmann codes C_{Gr}(ν₁) and C_{Gr}(ν₂), and the minimum distance is bounded below by the minimum of the minimum distance of the code C_{Gr}(ν₂) and the minimum distance of the code C_{Gr}(ν₁)^{⊥}.

15. The method of claim 10, wherein the line bundles [symbol] (ν) are restricted such that 1≤ν≤└ [symbol] (m− [symbol] )(q−1)/2┘ and 2ν≡0 mod (q−1).

16. The method of claim 15, wherein the higher Grassmann codes C_{Gr}(ν) are self-dual.

17. The method of claim 16, wherein ν^{⊥}= [symbol] (m− [symbol] )(q−1)−ν, as k(q−1)+ν, where k= [symbol] (m− [symbol] )−(2ν/(q−1)), and further comprising applying a CSS construction to the higher Grassmann codes, C_{Gr}(ν₁) and C_{Gr}(ν₂) to obtain quantum error correcting codes whose parameters are determined by the parameters of the higher Grassmann codes as follows: the length of the code will be the number of [symbol] _{q}-rational points on the Grassmannian, the dimension of the resulting quantum code is the difference of the dimensions of the two Grassmann codes C_{Gr}(ν₁) and C_{Gr}(ν₂), and the minimum distance is bounded below by the minimum of the minimum distance of the code C_{Gr}(ν₂) and the minimum distance of the code C_{Gr}(ν₁)^{⊥}.

18. A method for active recovery in a quantum error correction code, comprising
performing an error process E on a logical qubit |ψ [symbol] _{L} of an [[n, k, d]] stabilizer code;
measuring a generating set of stabilizers S on a logical state to yield an m-bit syndrome [symbol] ; and
processing the m-bit syndrome [symbol] by a decoder to determine a best recovery operation [symbol] to return the logical state to a codespace,
wherein after the recovery operation has been applied, the output of an error correction cycle is [symbol] E|ψ [symbol] _{L}.
